(19) United States
(12) Patent Application Publication
(10) Pub. No.: US 2026/0066282 A1
(43) Pub. Date: Mar. 5, 2026

(54) ELECTRODE ACTIVE MATERIAL, ELECTRODE LAYER, AND SOLID-STATE BATTERY

(71) Applicant: TOYOTA JIDOSHA KABUSHIKI KAISHA, Toyota-shi (JP)

(72) Inventors: Kazushige NOMOTO, Sunto-gun (JP); Jun Yoshida, Mishima-shi (JP); Ryosuke Furuya, Gotemba-shi (JP); Hirofumi Nakamoto, Sunto-gun (JP); So Yubuchi, Sunto-gun (JP); Chikuen Wong, Mishima-shi (JP)

(73) Assignee: TOYOTA JIDOSHA KABUSHIKI KAISHA, Toyota-shi (JP)

(21) Appl. No.: 19/223,624

(22) Filed: May 30, 2025

(30) Foreign Application Priority Data
Aug. 30, 2024 (JP) 2024-148208

(51) Int. Cl. H01M 4/38; H01M 4/02; H01M 4/134; H01M 4/62

(52) U.S. Cl. CPC H01M 4/386; H01M 4/134; H01M 4/623; H01M 2004/021; H01M 2004/027

(57) ABSTRACT

An electrode active material includes primary particles containing a silicon element, the primary particles being provided as secondary particles by a binder. The primary particles are porous, and an average pore size of pores of the primary particles is more than 4.1 nm. A molecular size D50 in a molecular size distribution of the binder is less than 1,859 nm. The molecular size D50 is equal to or larger than the average pore size.

### CROSS-REFERENCE TO RELATED APPLICATION

This application claims priority to Japanese Patent Application No. 2024-148208 filed on Aug. 30, 2024. The disclosure of the above-identified application, including the specification, drawings, and claims, is incorporated by reference herein in its entirety.

### BACKGROUND

### 1. Technical Field

The present disclosure relates to an electrode active material, an electrode layer, and a solid-state battery.

### 2. Description of Related Art

Various technologies have been proposed for electrodes and batteries such as one disclosed in Japanese Unexamined Patent Application Publication No. 2024-017797 (JP 2024-017797 A).

### SUMMARY

JP 2024-017797 A discloses a secondary battery negative electrode layer including an active material layer containing, as an active material, composite particles in which a plurality of porous silicon particles is bonded to each other via a binder, and the active material layer has a porosity of more than 15%. JP 2024-017797 A describes that, when the negative electrode layer has the above-mentioned specific porosity, the change in the thickness of the negative electrode during charging can be reduced, and that porous silicon particles including pores having a diameter of 55 nm or less are easily maintained in porosity even after pressing. However, there is still room for improvement in prevention of electrode expansion during charging and discharging.

The present disclosure has been made in view of the above-mentioned circumstances, and has a primary object to provide an electrode active material capable of preventing electrode expansion associated with charging and discharging.

That is, the present disclosure includes the following aspects.
<1> A first aspect of the disclosure relates to an electrode active material including primary particles containing a silicon element, the primary particles being provided as secondary particles by a binder.

The primary particles are porous, and an average pore size of pores of the primary particles is more than 4.1 nm.

A molecular size D50 in a molecular size distribution of the binder is less than 1,859 nm.

The molecular size D50 is equal to or larger than the average pore size.
<2> In the electrode active material according to <1>,
the average pore size of the pores of the primary particles may be 5 nm or more and 30 nm or less, and
the molecular size D50 in the molecular size distribution of the binder may be 25 nm or more and 1,000 nm or less.
<3> A second aspect of the disclosure relates to an electrode layer including the electrode active material of <1> or <2>.
<4> A third aspect of the disclosure relates to a solid-state battery including an electrode layer containing the electrode active material of <1> or <2>.
<5> In the solid-state battery according to <4>, the electrode layer may be a negative electrode layer.

With the electrode active material of the present disclosure, the electrode expansion associated with the charging and discharging can be prevented.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view illustrating an example of a solid-state battery of the present disclosure;

FIG. 2 is a graph illustrating results of Examples and Comparative Examples; and

FIG. 3 is a graph illustrating results of Examples and Comparative Examples.

### DETAILED DESCRIPTION OF EMBODIMENTS

Hereinafter, an embodiment of the present disclosure is described. It is to be noted that matters other than those specifically mentioned herein and necessary for the implementation of the present disclosure (for example, general configurations and manufacturing processes of an electrode active material, an electrode layer, and a solid-state battery that do not characterize the present disclosure) can be found as design matters by a person skilled in the art based on the related art in the pertinent field. The present disclosure can be carried out based on the contents disclosed herein and common technical knowledge in the pertinent field.

### A. Electrode Active Material

The present disclosure provides an electrode active material including primary particles containing a silicon element (hereinafter sometimes referred to as “Si-based primary particles”), the primary particles being provided as secondary particles by a binder. The primary particles are porous, and an average pore size of pores of the primary particles is more than 4.1 nm. A molecular size D50 in a molecular size distribution of the binder is less than 1,859 nm. The molecular size D50 is equal to or larger than the average pore size.

That is, the electrode active material of the present disclosure is an electrode active material including Si-based primary particles being porous (hereinafter sometimes referred to as “porous Si-based primary particles”), the porous Si-based primary particles being provided as secondary particles by a binder, and satisfies the following conditions (1) to (3):
(1) the average pore size of the pores of the porous Si-based primary particles is more than 4.1 nm;
(2) the molecular size D50 in the molecular size distribution of the binder is less than 1,859 nm; and
(3) the molecular size D50 of the binder is equal to or larger than the average pore size of the porous Si-based primary particles.

It has been found that, in an electrode active material in which a plurality of porous Si-based primary particles is combined by a binder, when the porous Si-based primary particles and the binder satisfying the above-mentioned conditions (1) to (3) are combined, expansion of an electrode associated with charging and discharging can be prevented.

When the average pore size of the porous Si-based primary particles is 4.1 nm or less, the pores are crushed in a densification process of the electrode layer, and hence it is considered that the expansion of the electrode layer cannot be prevented. Further, even when the molecular size D50 in the molecular size distribution of the binder is 1,859 nm or more, the expansion of the electrode layer cannot be prevented. Further, even when the average pore size of the porous Si-based primary particles is more than 4.1 nm and the molecular size D50 of the binder is less than 1,859 nm, when the molecular size D50 of the binder is smaller than the average pore size of the porous Si-based primary particles, binder molecules enter the pores of the porous Si-based primary particles to fill the pores, and hence it is considered that the expansion of the electrode layer cannot be prevented.

The average pore size of the porous Si-based primary particles is only required to be more than 4.1 nm, but may be 5 nm or more and 30 nm or less because a higher expansion absorption effect can be expected.

The molecular size D50 in the molecular size distribution of the binder is only required to be less than 1,859 nm, but may be 25 nm or more and 1,000 nm or less because a higher expansion absorption effect can be expected.

The average pore size of the porous Si-based primary particles may be 5 nm or more and 30 nm or less, and the molecular size D50 in the molecular size distribution of the binder may be 25 nm or more and 1,000 nm or less.

In the present disclosure, the average pore size of the pores of the porous Si-based primary particles is a value calculated by pore size distribution measurement using a DFT method by a gas adsorption amount measuring device (for example, a fully-automatic gas adsorption amount measuring device “autosorb-iQ” manufactured by Anton Paar GmbH).

It is to be noted that the average pore size can also be calculated by pore size distribution measurement by a BET apparatus, measurement by a mercury porosimeter, image analysis of a cross section by a scanning electron microscope (SEM), image analysis of a cross section by a transmission electron microscope (TEM), and the like.

Further, in the present disclosure, the molecular size D50 in the molecular size distribution of the binder is a value of a median diameter that is a molecular size at an integrated value 50% in the volume-base particle size distribution, and can be measured by a dynamic light scattering method.

It is to be noted that the molecular size D50 can also be calculated by a laser diffraction scattering method, an electrical sensing zone method, image analysis of a cross section by the SEM, image analysis of a cross section by the TEM, and the like.

The porous Si-based primary particles have a porous structure, that is, a plurality of pores (air gaps). As long as the average size of the pores falls within the above-mentioned range, the porosity of the porous Si-based primary particles is not particularly limited, and may be, for example, 1% or more or 10% or more. Further, the porosity of the porous Si-based primary particles may be 80% or less or 60% or less. The porosity can be calculated by, for example, sectional observation by the SEM.

As long as the porous Si-based primary particles contain a silicon element, the composition of the porous Si-based primary particles is not particularly limited, and examples of the composition include Si alone, an Si alloy, an Si oxide, and an Si carbide. The Si alloy is an alloy having Si as a main component. Examples of a metal other than Si in the Si alloy include Li, Sn, Fe, Co, Ni, Ti, Cr, Na, W, Mo, V, Nb, Zr, and Hf. The Si alloy may contain only one type of metal other than Si, or may contain two or more types of metals other than Si. Examples of the Si oxide include SiO. Further, examples of the Si carbide include SiC. Further, the porous Si-based primary particles may contain other elements such as B and P.

The porous Si-based primary particles may be crystalline or amorphous. When the porous Si-based primary particles are crystalline, a crystal layer of the porous Si-based primary particles is not particularly limited.

Only one type of porous Si-based primary particles may be used alone, or two or more types of porous Si-based primary particles may be used in combination.

The average particle size (D50) of the porous Si-based primary particles is not particularly limited, and may be, for example, 10 nm or more or 50 nm or more, and may be 10 μm or less or 1 μm or less.

Here, the average particle size (D50) of the porous Si-based primary particles is a value of a median diameter (D50) that is a particle size at an integrated value 50% in the volume-base particle size distribution to be measured by laser diffraction-scattering particle size distribution measurement.

The binder binds and combines the porous Si-based primary particles. The type of the binder is not particularly limited as long as the molecular size D50 in the molecular size distribution falls within the above-mentioned range. Specific examples of the binder include styrene-butadiene rubber (SBR), acrylonitrile-butadiene rubber (NBR), butadiene rubber (BR), polyvinylidene fluoride (PVdF), polytetrafluoroethylene (PTFE), butyl rubber (IIR), acrylonitrile-butadiene rubber (ABR), polyimide (IR), carboxymethyl cellulose (CMC), polyacrylate, polyacrylic acid ester, styrene-isoprene-styrene block copolymer (SIS), and ethylene-propylene-diene copolymer (EPDM). Only one type of binder may be used alone, or two or more types of binders may be used in combination.

When an electrode mixed material slurry is used at the time of forming the electrode layer, from the viewpoint of maintaining a particle shape of secondary particles, a binder that is poorly soluble in a solvent of the electrode mixed material slurry may be selected. For example, when an organic solvent such as mesitylene or tetralin is used as the solvent of the electrode mixed material slurry, a vinyl-based binder such as PVdF may be used as the binder.

The ratio between the porous Si-based primary particles and the binder in the secondary particles is not particularly limited. When the entire electrode active material is regarded as 100% by mass, for example, the binder is 1% by mass or more, and may be 5% by mass or more. Further, the binder is 30% by mass or less, and may be 25% by mass or less.

The particle size of the secondary particles is not particularly limited. For example, the average particle size (D50) is 100 nm or more, and may be 1 μm or more. Further, the average particle size (D50) is 20 μm or less, and may be 15 μm or less. The average particle size (D50) of the secondary particles is a value of a median diameter (D50) that is a particle size at an integrated value 50% in the volume-base particle size distribution to be measured by laser diffraction-scattering particle size distribution measurement.

For example, the electrode active material of the present disclosure can be produced as follows. That is, first, a binder solution in which a binder is dissolved or dispersed in an organic solvent is prepared. Subsequently, the porous Si-based primary particles are put into the binder solution, and thus a primary particle slurry is prepared. The obtained primary particle slurry is sprayed and dried (spray-dried) so that the porous Si-based primary particles are provided as secondary particles. The condition of the spray-drying is not particularly limited as long as the porous Si-based primary particles can be provided as secondary particles.

The electrode active material of the present disclosure can be used as a negative electrode active material, or can be used as a positive electrode active material, but a higher effect can be expected when the electrode active material of the present disclosure is used as the negative electrode active material.

### B. Electrode Layer

The electrode layer of the present disclosure contains “A. Electrode Active Material” described above. When the electrode active material of the present disclosure is used as the negative electrode active material, the electrode layer of the present disclosure is a negative electrode layer. When the electrode active material of the present disclosure is used as the positive electrode active material, the electrode layer of the present disclosure is a positive electrode layer.

The ratio of the electrode active material in the electrode layer is not particularly limited. For example, when the entire electrode layer is regarded as 100% by mass, the ratio of the electrode active material in the electrode layer is 40% by mass or more, and may be 55% by mass or more. Further, the ratio of the electrode active material in the electrode layer is 99% by mass or less, and may be 80% by mass or less.

The electrode layer may contain only the electrode active material, or may contain other components, for example, at least one of a solid electrolyte, an electrically conductive material, and a binder other than the binder configuring the above-mentioned electrode active material (which may hereinafter be referred to as “electrode layer binder)” as required.

Examples of the solid electrolyte include inorganic solid electrolytes such as a sulfide solid electrolyte, a halide solid electrolyte, an oxide solid electrolyte, and a complex hydride solid electrolyte, and organic solid electrolytes such as a gel electrolyte. Among them, the solid electrolyte may be the sulfide solid electrolyte. The reason therefor is because ion conductivity is high. The sulfide solid electrolyte is an electrolyte containing an S element as a main component of the anion constituent.

The sulfide solid electrolyte generally contains at least an Li element and an S element. The sulfide solid electrolyte may further contain an Me element (Me is at least one type among P, As, Sb, Si, Ge, Sn, B, Al, Ga, and In). Further, the sulfide solid electrolyte may contain a halogen element such as F, Cl, Br, and I.

The sulfide solid electrolyte may be a glass-based (amorphous-based) sulfide solid electrolyte, a glass-ceramic-based sulfide solid electrolyte, or a crystal-based sulfide solid electrolyte. The sulfide solid electrolyte may have a crystal phase. Examples of the crystal phase include a Thio-LISICON type crystal phase, an argyrodite type crystal phase, and an LGPS type crystal phase.

The composition of the sulfide solid electrolyte is not particularly limited, and examples of the composition include xLi₂S·(1−x) P₂S₅ (0.5≤x<1) and yLiI·zLiBr·(100−y−z) (xLi₂S·(1−x) P₂S₅) (0.5≤x<1, 0≤y≤30, 0≤z≤30). In those compositions, x may satisfy 0.7≤x≤0.8. Further, Li₇₋ₓPS₆₋ₓXₓ can be given as another example of the composition of the sulfide solid electrolyte. X is at least one type of F, Cl, Br, and I, and x satisfies 0≤x<2. Further, Li₄₋ₓMe₁₋ₓPₓS₄ (0<x<1) can be given as another example of the composition of the sulfide solid electrolyte. Me is at least one type among Al, Zn, In, Ge, Si, Sn, Sb, Ga, and Bi. Examples of the sulfide solid electrolyte include LiI—LiBr—Li₂S—P₂S₅, LiI—Li₂S—P₂S₅, LiI—Li₂S—P₂O₅, and LiI—Li₃PO₄—P₂S₅.

Examples of the oxide solid electrolyte include substances having a garnet type crystal structure including an Li element, an La element, an A element (A is at least one type of Zr, Nb, Ta, and Al), and an O element. Examples of the oxide solid electrolyte include Li₂O—B₂O₃—P₂O₅, Li₂O—SiO₂, Li₂O—B₂O₃, Li_{1.3}Al_{0.3} Ti_{0.7} (PO₄)₃, Li₅La₃Ta₂O₁₂, Li₇La₃Zr₂O₁₂, Li₆BaLa₂Ta₂O₁₂, Li_{3.6}Si_{0.6}P_{0.4}O₄, Li₄SiO₄, Li₃PO₄, and Li₃₊ₓPO₄₋ₓNₓ (1≤x≤3).

Examples of the halide solid electrolyte include a solid electrolyte containing Li, M, and X (M represents at least one of Ti, Al, and Y, and X represents F, Cl, or Br).

Only one type of solid electrolyte may be used alone, or two or more types of solid electrolytes may be used in combination. The ratio of the solid electrolyte in the electrode layer is, for example, when the entire electrode layer is regarded as 100% by mass, 1% by mass or more, and may be 20% by mass or more. Further, the ratio of the solid electrolyte in the electrode layer is 60% by mass or less, and may be 45% by mass or less.

Examples of the electrically conductive material include carbon materials, metal materials, and electrically conductive polymers. The shape of the electrically conductive material may be, for example, a particle shape or a fiber shape. Examples of the carbon materials include particulate carbon materials such as Acetylene Black (AB) and Ketjen Black (KB), and fibrous carbon materials such as vapor grown carbon fibers (VGCF), carbon nanotubes (CNT), and carbon nanofibers (CNF). Only one type of electrically conductive material may be used alone, or two or more types of electrically conductive materials may be used in combination.

The ratio of the electrically conductive material in the electrode layer is, for example, when the entire electrode layer is regarded as 100% by mass, 0.1% by mass or more, and may be 1.0% by mass or more. Further, the ratio of the electrically conductive material in the electrode layer is 5% by mass or less, and may be 3% by mass or less.

The electrode layer binder may be of the same type as or of a different type from the binder included in the above-mentioned electrode active material. However, as described above, when the electrode layer is formed with the use of the electrode mixed material slurry, while the binder configuring the electrode active material may be of a type that is poorly soluble in the solvent of the electrode mixed material slurry, the electrode layer binder may be of a type that is dissolved or dispersed in the solvent of the electrode mixed material slurry. For example, when an organic solvent such as mesitylene or tetralin is used as the solvent of the electrode mixed material slurry, SBR may be used as the electrode layer binder.

The ratio of the electrode layer binder in the electrode layer is, for example, when the entire electrode layer is regarded as 100% by mass, 0.5% by mass or more, and may be 1.5% by mass or more. Further, the ratio of the electrode layer binder in the electrode layer is 5% by mass or less, and may be 3% by mass or less.

The electrode layer of the present disclosure is generally used for a battery. The type of the battery is not particularly limited, and, since the effect of preventing electrode expansion associated with charging and discharging is particularly high, a better effect can be expected when the electrode layer is used as an electrode layer of a solid-state battery.

The thickness of the electrode layer is, for example, 0.1 μm or more and 1,000 μm or less, and may be 1 μm or more and 500 μm or less or 30 μm or more and 100 μm or less.

A method of manufacturing the electrode layer is not particularly limited, and, for example, the following method can be given. That is, first, the electrode mixed material slurry is prepared by mixing the electrode active material with a solvent together with the solid electrolyte, the electrically conductive material, the electrode layer binder, and
the like as required. Next, the electrode layer is formed by applying the electrode mixed material slurry to an electrode current collector and drying the electrode mixed material slurry. The electrode layer may be pressed in its thickness direction and densified as required.

### C. Solid-State Battery

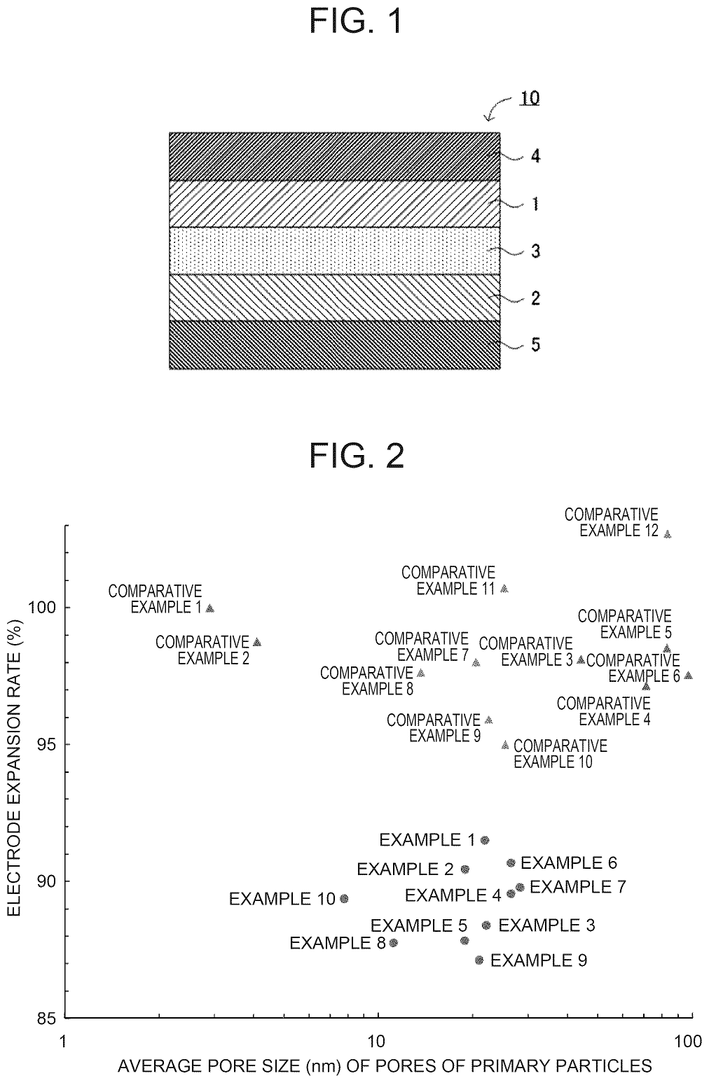

FIG. 1 is a schematic sectional view illustrating an example of a solid-state battery in the present disclosure. A solid-state battery 10 illustrated in FIG. 1 includes a positive electrode layer 1, a negative electrode layer 2, an electrolyte layer 3 disposed between the positive electrode layer 1 and the negative electrode layer 2, a positive electrode current collector 4 that collects current of the positive electrode layer 1, and a negative electrode current collector 5 that collects current of the negative electrode layer 2. In the present disclosure, the positive electrode layer 1 or the negative electrode layer 2 is the electrode layer described in “B. Electrode Layer” above.

With the use of the electrode layer containing the electrode active material of the present disclosure, a solid-state battery having small electrode expansion associated with charging and discharging can be obtained. In the solid-state battery of the present disclosure, the electrode layer containing the electrode active material of the present disclosure may be the negative electrode layer or the positive electrode layer, but a higher effect can be expected when the electrode layer is the negative electrode layer.

The solid-state battery in the present disclosure may be a semi-solid-state battery or an all-solid-state battery. In the present disclosure, the semi-solid-state battery is a battery in which the electrolyte layer includes a solid electrolyte and a liquid component (for example, ionic liquid). In the present disclosure, the all-solid-state battery is a battery in which the electrolyte layer includes only a solid electrolyte as an electrolyte.

### 1. Negative Electrode Layer

A case in which the negative electrode layer is the electrode layer of the present disclosure is similar to the contents described in “B. Electrode Layer” above, and hence description thereof is omitted here. Here, description is given of a negative electrode layer when the positive electrode layer is the electrode layer described in “B. Electrode Layer” above.

The negative electrode layer at least contains a negative electrode active material. Examples of the negative electrode active material include an Si-based active material, a carbon-based active material, an oxide-based active material, and an Li-based active material.

Examples of the Si-based active material include Si alone, an Si alloy, an Si oxide, and an Si carbide that are exemplified as the porous Si-based primary particles in “A. Electrode Active Material” above.

Examples of the carbon-based active material include graphite, hard carbon, and soft carbon.

Examples of the oxide-based active material include lithium titanate.

Examples of the Li-based active material include Li alone and an Li alloy. Examples of a metal element other than lithium included in the Li alloy include Mg, Ag, In, Sn, Si, Ga, Au, and Pt.

The negative electrode layer may contain at least one of a solid electrolyte, an electrically conductive material, and a binder (an electrode layer binder) as required. The solid electrolyte, the electrically conductive material, and the electrode layer binder are similar to those in “B. Electrode Layer” above, and hence description thereof is omitted here.

### 2. Positive Electrode Layer

A case in which the positive electrode layer is the electrode layer of the present disclosure is similar to the contents described in “B. Electrode Layer” above, and hence description thereof is omitted there. Here, description is given of a positive electrode layer when the negative electrode layer is the electrode layer described in “B. Electrode Layer” above.

The positive electrode layer at least contains a positive electrode active material. Examples of the positive electrode active material include an oxide active material. Examples of the oxide active material include rock salt bed type active materials such as LiCoO₂, LiMnO₂, LiNiO₂, LiVO₂, LiNi_{1/3}Co_{1/3}Mn_{1/3}O₂, and LiNi_{0.8}Co_{0.15}Mn_{0.05}O₂, spinel type active materials such as LiMn₂O₄, Li₄Ti₅O₁₂, and Li(Ni_{0.5}Mn_{1.5})O₄, and olivine type active materials such as LiFePO₄, LiMnPO₄, LiNiPO₄, and LiCoPO₄.

A coating layer containing an Li ion conductive compound may be formed on the surface of the positive electrode active material. The reason therefor is to inhibit the reaction of the positive electrode active material with the solid electrolyte (in particular, the sulfide solid electrolyte). Examples of the Li ion conductive compound include B₂O₃, Li₂B₄O₇, LiBPO₄, Li₃PO₄, LiPO₃, and LiNbO₃. The thickness of the coating layer is, for example, 1 nm or more and 30 nm or less. The coverage of the Li ion conductive compound covering the positive electrode active material is, for example, 70% or more, and may be 90% or more or 100%. A covering method of the Li ion conductive compound is not particularly limited, and a conventional publicly-known method can be adopted as appropriate.

The positive electrode layer may contain at least one of a solid electrolyte, an electrically conductive material, and a binder (an electrode layer binder) as required. The solid electrolyte, the electrically conductive material, and the electrode layer binder are similar to those in “B. Electrode Layer” above, and hence description thereof is omitted here.

### 3. Electrolyte Layer

The electrolyte layer is a layer formed between the positive electrode layer and the negative electrode layer, and is a solid electrolyte layer containing at least a solid electrolyte. The solid electrolyte is similar to the contents described in “B. Electrode Layer” above, and hence description thereof is omitted here.

Only one type of solid electrolyte can be used alone, or two or more types of solid electrolytes can be used in combination. Further, when two or more types of solid electrolytes are used, the two or more types of solid electrolytes may be mixed, or a multilayer structure may be obtained by forming two or more layers of solid electrolytes.

The ratio of the solid electrolyte in the electrolyte layer is not particularly limited, and is, for example, 50% by mass or more, or may fall within a range of 60% by mass or more and 100% by mass or less or fall within a range of 70% by mass or more and 100% by mass or less, or may be 100% by mass. The solid electrolyte may contain an electrolyte solution of less than 10% by mass with respect to the total amount of the electrolyte. It is to be noted that the solid electrolyte may be a composite solid electrolyte containing an inorganic solid electrolyte and a polymer electrolyte.

The electrolyte layer contains a binder or the like as required. As a binder, a binder that can be included in the electrode layer described above can be exemplified. When the electrolyte layer contains a binder, the content of the binder may be 0% by mass to 10% by mass with respect to the total amount of the electrolyte layer.

The thickness of the electrolyte layer is, for example, 0.1 μm or more and 1,000 μm or less, and may be 0.1 μm or more and 500 μm or less or 0.1 μm or more and 100 μm or less.

### 4. Other Configurations

The solid-state battery in the present disclosure may include a positive electrode current collector that collects current of the positive electrode layer, and a negative electrode current collector that collects current of the negative electrode layer.

Examples of the material of the positive electrode current collector include SUS, Cr, Au, Pt, Zn, aluminum, copper, nickel, iron, titanium, and carbon. The thickness of the positive electrode current collector is, for example, 0.1 μm or more and 100 μm or less. The shape of the positive electrode current collector may be a foil shape or a plate shape. The positive electrode current collector may have a configuration in which a buffer layer, an elastic layer, or a positive temperature coefficient (PTC) thermistor layer is disposed on the surface.

Examples of the material of the negative electrode current collector include SUS, aluminum, copper, nickel, iron, titanium, and carbon. Examples of the shape of the negative electrode current collector include a foil shape and a plate shape. The shape of the negative electrode current collector in plan view is not particularly limited, and examples of the shape include a circular shape, an elliptical shape, a rectangular shape, and any polygonal shape. Further, the thickness of the negative electrode current collector varies depending on the shape, and may fall within the range of, for example, 1 μm to 50 μm. The negative electrode current collector may have a configuration in which a buffer layer, an elastic layer, or a PTC thermistor layer is disposed on the surface.

The solid-state battery of the present disclosure may further include a restraining jig that applies a restraining pressure along the thickness direction to the positive electrode layer, the electrolyte layer, and the negative electrode layer. The restraining pressure is, for example, 0.1 MPa or more, and may be 1 MPa or more or 5 MPa or more. Meanwhile, the restraining pressure is, for example, 100 MPa or less, and may be 50 MPa or less or 20 MPa or less.

### 5. Solid-State Battery

The type of the solid-state battery in the present disclosure is not particularly limited, and is typically a lithium ion battery. Further, the solid-state battery in the present disclosure may be a primary battery or a secondary battery, and may particularly be a secondary battery. The reason therefor is because the battery can be repeatedly charged and discharged, and is effective as, for example, an in-vehicle battery.

The shape of the battery is not particularly limited, and may be, for example, a coin shape, a cylindrical shape, a rectangular shape, a sheet shape, a button shape, a flat shape, or a stack shape.

Examples of the application of the solid-state battery include power supplies of vehicles such as a hybrid electric vehicle (HEV), a plug-in hybrid electric vehicle (PHEV), a battery electric vehicle (BEV), a gasoline-powered vehicle, and a diesel-powered vehicle. In particular, the solid-state battery may be used for a driving power supply of a hybrid electric vehicle (HEV), a plug-in hybrid electric vehicle (PHEV), or a battery electric vehicle (BEV). Further, the solid-state battery may be used as a power supply of a moving body other than a vehicle (for example, a railway vehicle, a ship, or an aircraft), or may be used as a power supply of an electrical product such as an information processing device.

It is to be noted that the present disclosure is not limited to the above-mentioned embodiment. The above-mentioned embodiment is merely an example, and thus any of those substantially having the same configuration as the technological idea disclosed in the claims of the present disclosure for achieving similar actions and effects is incorporated in the technological scope of the present disclosure.

### Production of Solid-State Battery

### Example 1

### Production of Electrode Active Material

A porous Si particle slurry was prepared by putting porous Si-based primary particles (having an average pore size of 21.9 nm) into a solution obtained by dissolving or dispersing a binder (PVdF, having a molecular size D50 in a molecular size distribution of 25.3 nm) in an organic solvent. With the use of the obtained porous Si particle slurry, the porous Si-based primary particles were provided as secondary particles by the spray drying method, and thus the electrode active material was obtained.

The molecular size D50 in the molecular size distribution of PVdF was measured by using a dynamic light scattering method. Further, the average pore size of the porous Si-based primary particles was measured with the use of a fully-automatic gas adsorption amount measuring device (“autosorb-iQ” manufactured by Anton Paar GmbH).

### Production of Negative Electrode

The obtained electrode active material was added into an organic solvent (tetralin) together with an electrode layer binder (SBR), an electrically conductive material, and a solid electrolyte. After the addition, kneading was performed with the use of an ultrasonic homogenizer, and thus a negative electrode mixed material slurry was prepared. The obtained negative electrode mixed material slurry was applied onto a Cu foil, and thus a negative electrode in which the negative electrode layer was stacked on the negative electrode current collector (Cu foil) was produced.

### Production of Positive Electrode

A positive electrode mixed material slurry was prepared by adding a binder, an electrically conductive material, a solid electrolyte, and a positive electrode active material (LiNi_{0.8}Co_{0.15}Mn_{0.05}O₂) to an organic solvent and performing kneading with the use of an ultrasonic homogenizer. The obtained positive electrode mixed material slurry was applied onto an Al foil, and thus a positive electrode in which the positive electrode layer was stacked on the positive electrode current collector (Al foil) was produced.

### Production of Electrolyte Layer

A binder and a solid electrolyte were added into an organic solvent. After the addition, kneading was performed with the use of an ultrasonic homogenizer, and thus an electrolyte mixed material slurry was obtained. The obtained electrolyte mixed material slurry was applied onto an Al foil, and thus an electrolyte layer sheet in which a solid electrolyte layer was stacked on the Al foil was produced.

### Production of Solid-State Battery

Each of the layers produced as described above was formed (cut) into a strip shape.

The positive electrode and the electrolyte layer sheet were stacked so that the positive electrode layer surface of the positive electrode and the electrolyte layer surface of the electrolyte layer sheet faced each other, and roll-pressing was performed at 165° C. and a pressure of 50 kN/cm. Next, the Al foil of the electrolyte layer sheet was removed, and the electrolyte layer was transferred onto the positive electrode layer of the positive electrode.

Meanwhile, the negative electrode and the electrolyte layer sheet were stacked so that the negative electrode layer surface of the negative electrode and the electrolyte layer surface of the electrolyte layer sheet faced each other, and roll-pressing was performed at 25° C. and a pressure of 50 kN/cm. Next, the Al foil of the electrolyte layer sheet was removed, and the electrolyte layer was transferred onto the negative electrode layer of the negative electrode.

Subsequently, the negative electrode having the electrolyte layer transferred thereon was punched out at φ13.00 mm, and the positive electrode having the electrolyte layer transferred thereon was punched out at φ11.28 mm. The negative electrode layer having the electrolyte layer transferred thereon and the positive electrode layer having the electrolyte layer transferred thereon were subjected to uniaxial pressing in a state in which the negative electrode layer and the positive electrode layer were stacked to face each other. In this manner, the negative electrode current collector, the negative electrode layer, the electrolyte layer, the positive electrode layer, and the positive electrode current collector were stacked in the stated order to be provided as a battery.

Moreover, after current extraction tabs were attached to the positive electrode and the negative electrode, the battery was sealed in an aluminum laminate by a vacuum laminator. Finally, the battery was restrained in the thickness direction at a pressure of 5 MPa, and thus the solid-state battery was produced.

### Examples 2 to 10 and Comparative Examples 1 to 12

The solid-state battery was produced similarly to Example 1 except that the electrode active material was produced with the use of PVdF having the molecular size D50 shown in Table 1 and porous Si-based primary particles having the average pore size shown in Table 1.

### Evaluation of Electrode Expansion Rate

The solid-state batteries of Examples 1 to 10 and Comparative Examples 1 to 12 were each disassembled and cut and subjected to ion milling processing before and after the charging and discharging. A composite electronic image of a processed cross section was acquired by the SEM, and an electrode expansion rate [(thickness of negative electrode layer after charging and discharging)/(thickness of negative electrode layer before charging and discharging)×100%] was calculated from the thicknesses of the negative electrode layer before and after the charging and discharging. The results are shown in Table 1.

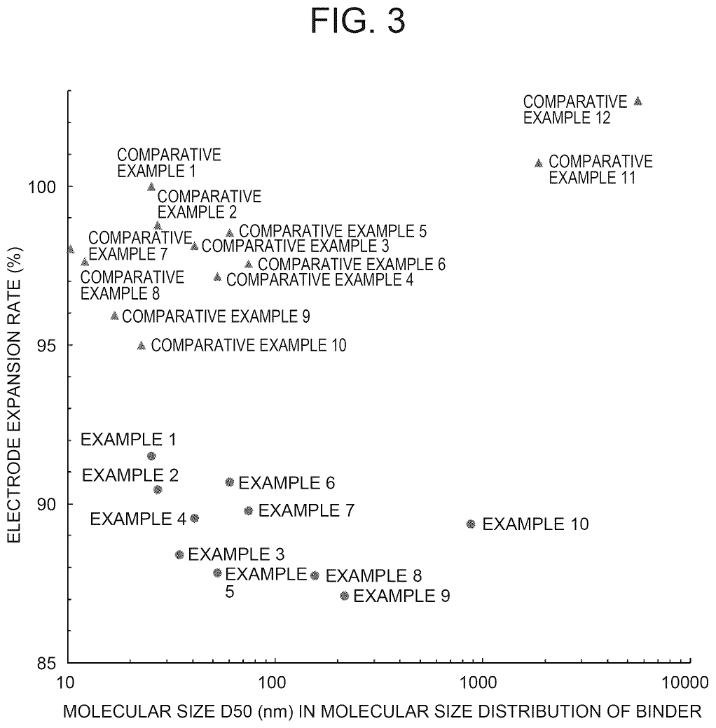

Further, the relationship between the average pore size of the porous Si-based primary particles and the electrode expansion rate is illustrated in FIG. 2, and the relationship between the molecular size D50 in the molecular size distribution of the binder and the electrode expansion rate is illustrated in FIG. 3.

It is to be noted that the electrode expansion rate in Table 1, FIG. 2, and FIG. 3 is a relative value in a case in which the result of Comparative Example 1 is regarded as 100.

TABLE 1

| | Molecular size | Average pore | |
|---|---|---|---|
| | D50 (nm) in | size (nm) | Electrode |
| | molecular size | of porous Si- | expansion |
| | distribution | based primary | rate |
| | of binder | particles | (%) |
| Comparative Example 1 | 25.3 | 2.9 | 100.0 |
| Comparative Example 2 | 27.1 | 4.1 | 98.8 |
| Comparative Example 3 | 40.8 | 44.2 | 98.1 |
| Comparative Example 4 | 52.6 | 71.3 | 97.2 |
| Comparative Example 5 | 60.3 | 83.1 | 98.5 |
| Comparative Example 6 | 74.3 | 97.1 | 97.6 |
| Comparative Example 7 | 10.3 | 20.5 | 98.0 |
| Comparative Example 8 | 12.1 | 13.7 | 97.6 |
| Comparative Example 9 | 16.8 | 22.5 | 95.9 |
| Comparative Example 10 | 22.6 | 25.4 | 95.0 |
| Comparative Example 11 | 1859 | 25.2 | 100.7 |
| Comparative Example 12 | 5597 | 83.4 | 102.7 |
| Example 1 | 25.3 | 21.9 | 91.5 |
| Example 2 | 27.1 | 18.9 | 90.4 |
| Example 3 | 34.5 | 22.1 | 88.4 |
| Example 4 | 40.8 | 26.5 | 89.5 |
| Example 5 | 52.6 | 18.9 | 87.8 |
| Example 6 | 60.3 | 26.5 | 90.7 |
| Example 7 | 74.3 | 28.3 | 89.8 |
| Example 8 | 154.8 | 11.2 | 87.7 |
| Example 9 | 216.3 | 21.0 | 87.1 |
| Example 10 | 876.5 | 7.8 | 89.4 |

As shown in Table 1, FIG. 2, and FIG. 3, it was confirmed that Examples 1 to 10 had electrode expansion rates smaller than any one of Comparative Examples 1 to 12.

Specifically, in Comparative Examples 1 and 2 in which the average pore size of the porous Si-based primary particles used in the production of the electrode active material was 4.1 nm or less and Comparative Examples 11 and 12 in which the molecular size D50 of the binder used in the production of the electrode active material was 1,859 nm or more, even when the molecular size D50 of the binder was equal to or larger than the average pore size of the porous Si-based primary particles, the electrode expansion rate was increased as compared with Examples 1 to 10.

Further, in Comparative Examples 3 to 10 in which the molecular size D50 of the binder was smaller than the average pore size of the porous Si-based primary particles, even when the average pore size of the porous Si-based primary particles was more than 4.1 nm and the molecular size D50 of the binder was less than 1,859 nm, the electrode expansion rate was increased as compared with Examples 1 to 10.

What is claimed is:

1. An electrode active material comprising primary particles containing a silicon element, the primary particles being provided as secondary particles by a binder, wherein:
the primary particles are porous, and an average pore size of pores of the primary particles is more than 4.1 nm;
a molecular size D50 in a molecular size distribution of the binder is less than 1,859 nm; and
the molecular size D50 is equal to or larger than the average pore size.

2. The electrode active material according to claim 1, wherein:
the average pore size of the pores of the primary particles is 5 nm or more and 30 nm or less; and
the molecular size D50 in the molecular size distribution of the binder is 25 nm or more and 1,000 nm or less.

3. An electrode layer comprising the electrode active material of claim 1.

4. A solid-state battery comprising an electrode layer containing the electrode active material of claim 1.

5. The solid-state battery according to claim 4, wherein the electrode layer is a negative electrode layer.
